(19) United States
(12) Patent Application Publication
(10) Pub. No.: US 2007/0265771 A1
(43) Pub. Date: Nov. 15, 2007

(54) Portable Video Device Combined with Global Positioning System

(76) Inventor: Juen-Tien Peng, Chung Li (TW)

Correspondence Address: HDSL, 4331 STEVENS BATTLE LANE, FAIRFAX, VA, 22033, US

(21) Appl. No.: 11/382,705

(22) Filed: May 10, 2006

(51) Int. Cl. G01C 21/32

(52) U.S. Cl. 701/208; 701/211; 701/213

(57) ABSTRACT

A portable video device in combination with a positioning system includes a main body, a DVD system chip, a GPS receiving module, a memory card reader, a DVD device, and a display. The main body includes a GPS slot allowing the GPS receiving module to plug in. The DVD system chip is connected to a random access memory and a program storage memory. The GPS receiving module is inserted into the GPS slot and electrically connected to the DVD system chip. The GPS receiving module includes a GPS receiving antenna and a signal decoding chip. The memory card reader, the DVD device, and the display are connected to the DVD system chip. Thereby, the DVD system chip is operative to integrate and process the data transmitted from the map data DVD and the GPS signal received by the GPS receiving module into the navigation information presented on the display.

### BACKGROUND

The present invention relates in general to a video device, and in more particular, to a video device incorporating a Global Positioning System (GPS).

Currently, some GPS systems have been combined with a compact disc player as shown in FIG. 1. The combined system is in the form of a platform 100 which comprises a GPS system 10 and a DVD player 20. The GPS system includes a GPS chip (GPS SOC) 11, a GPS receiving module 12, and a memory card reader 13. The GPS SOC 11 is connected to the GPS receiving module 12 for receiving a GPS signal. The memory card reader 13 is used to read a map data memory card 131 or a multimedia data memory card 132 and input the map data to the GPS SOC 11. The GPS SOC 11 converts the map data into an image signal into to a screen 101 for display. The GPS SOC 11 is further connected to a random access memory 14 and a program storage memory 15. The DVD player 20 includes a DVD chip (DVD SOC) 21 and a DVD device 22. The DVD SOC 21 includes a random access memory 23 and a program storage memory 24, while the DVD device 22 is used to read a DVD 221 and to input video data into the DVD SOC 21, so as to generate an image signal input to a screen 101 for display.

The combined device as described simply installs an independently operable DVD platform and an independently operable GPS within the same platform. As the system structure has not been integrated structure, the cost is still too high. In addition, the typical GPS device uses a memory card as the storage medium. Currently, the memory card is still quite expensive and the memory capacity is still very limited. Therefore, when the user intends to use the GPS system for a long journey, the space of the memory card may be insufficient to provide all the required map data.

It is therefore a substantial need for integrating the GPS system and the DVD player to provide a combined GPS and DVD system in a lower cost. Therefore, the system can be more commonly used.

### BRIEF SUMMARY

A portable GPS and DVD system with an integrated system structure is provided and fabricated in a low cost. The GPS and DVD system uses the DVD device as the major storage medium, such that the system is operative to provide sufficient space to store the map data required for a long distance.

The portable video device in combination with a positioning system of the invention includes a main body, a DVD system chip, a GPS receiving module, a memory card reader, a DVD device, and a display. The main body includes a GPS slot allowing the GPS receiving module to plug in. The DVD system chip is connected to a random access memory and a program storage memory. The GPS receiving module is inserted into the GPS slot and electrically connected to the DVD system chip. The GPS receiving module includes a GPS receiving antenna and a signal decoding chip. The memory card reader, the DVD device, and the display are connected to the DVD system chip. Thereby, the DVD system chip is operative to integrate and process the data transmitted from the map data DVD and the GPS signal received by the GPS receiving module into the navigation information presented on the display.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a conventional GPS and DVD system; and

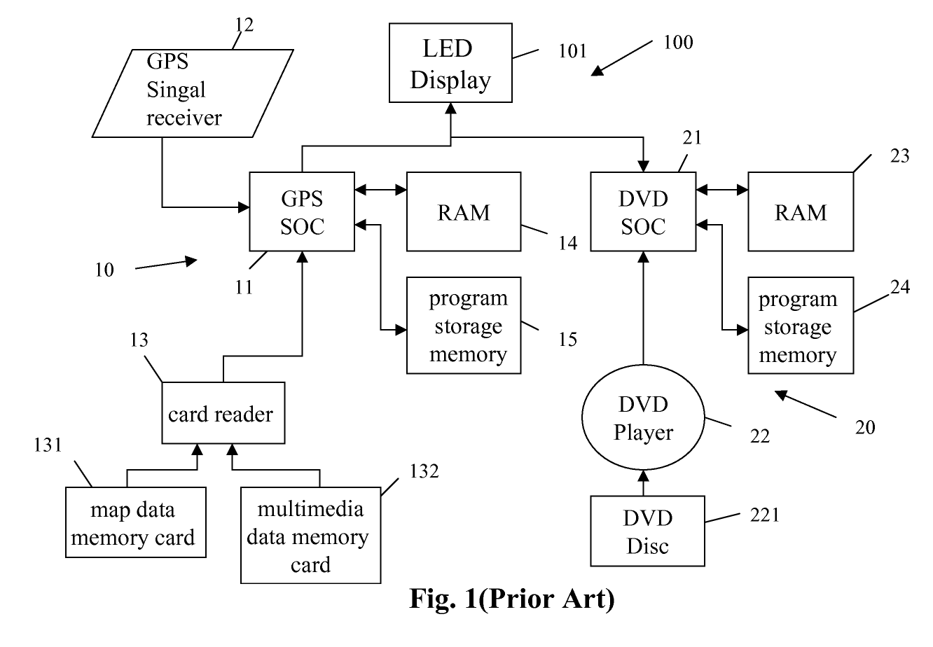

FIG. 2 shows an integrated GPS and DVD system.

### DETAILED DESCRIPTION

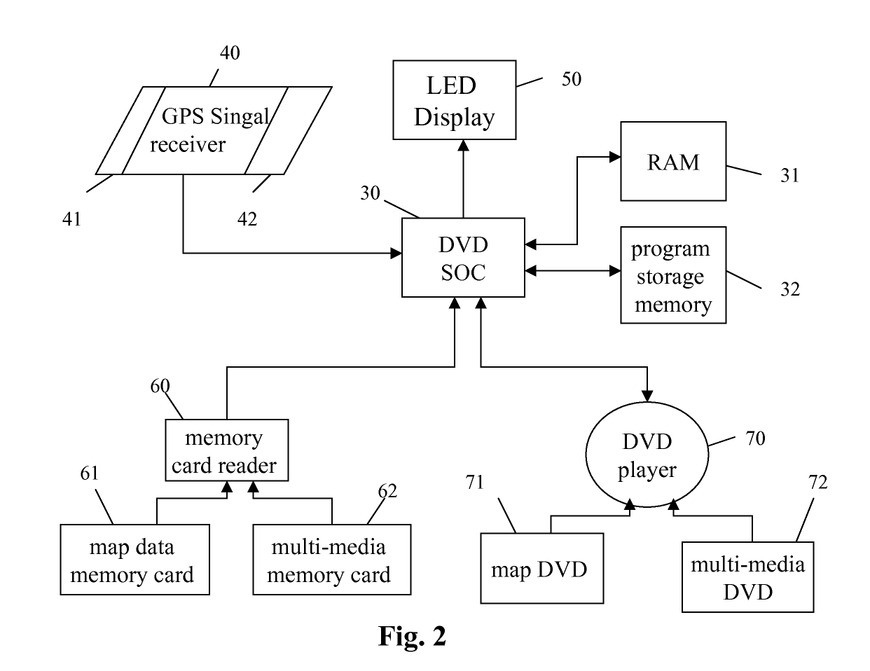

As shown in FIG. 2, the GPS and DVD system includes a DVD SOC 30, a GPS receiving module 40, a screen 50, a memory card reader 60 and a DVD device 70. The DVD SOC 30 is connected to a random access memory 31 and a program storage memory 32. The DVD SOC 30 is operative to receive a GPS signal via the GPS receiving module 40. The GPS receiving module 40 is electrically connected to the DVD SOC 30 and includes a receiving antenna 41 and a chip 42 for decoding the received signal. When a signal is received by the GPS receiving antenna 41 and decoded by the GPS chip 42, the decoded signal is transmitted to the DVD SOC 30. The memory card reader 60 is connected to the DVD SOC 30 allowing a map data memory card 61 or a multi-media memory card 62 to plug in. The data saved in the map data memory card 61 and the multi-media memory card 62 includes map information and video/audio information, respectively. The DVD device 70 is operative to read a map data or a video/audio data of a DVD and transmit the read data to the DVD SOC 30. When the video/audio data of a multi-media DVD 72 is read by the DVD device 70 and the video/audio data of a multimedia memory card 62 is read by a memory card reader 60, the read video/audio information is then played on the screen 50. When the DVD device 70 reads the map information from the map DVD 71 and the memory card reader 60 read the map information stored in the map data memory card 61, by execution of a software program and combining the GPS signal received by the GPS receiving module 40, the navigation information is processed and displayed on the screen 50.

The portable GPS and DVD system includes a main body for accommodating the devices as discussed above. The main body includes a GPS slot electrically connected to the DVD SOC 30. The GPS slot is used to install the GPS receiving module 40. It will be appreciated that the GPS receiving module 40 can also be built in the main body and electrically connected to the DVD SOC 30 directly.

The integration of the DVD system and the GPS system resolves the problem of the system which mechanically integrates the DVD system and the GPS system and provides more economic solution for application. Further, as the map and image data are stored in a DVD via the DVD device of the video device, the memory capacity is unlimited. The system may also include both the DVD and the memory card to provide flexibility in application.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A portable GPS and video combined device, comprising:
a DVD system chip connected to a random access memory and a program storage memory;
a GPS receiving module electrically connected to the DVD system chip, comprising a GPS receiving antenna and a signal decoding chip;
a memory card reader connected to the DVD system chip; and
a display connected to the DVD system chip.

2. The device of claim 1, wherein the memory card reader is operative to accommodate a map data memory card or a multimedia memory card to plug in and operative to transmit data stored in the map data or multimedia memory card to the DVD system chip.

3. The device of claim 1, further comprising a DVD player for accessing a map data DVD or a multimedia DVD.

4. The device of claim 1, wherein the DVD system chip includes a software program for processing a GPS signal and map information.

5. A portable video device incorporating with a GPS system, comprising:
a main body includes a GPS slot;
a DVD system chip built in the main body and connected to a random access memory and a program storage memory;
a GPS receiving module inserted in the GPS slot and electrically connected to the DVD system chip, the GPS receiving module includes a GPS receiving antenna and a signal decoding chip;
a memory card reader connected to the DVD system chip;
a DVD device connected to the DVD system chip; and
a display connected to the DVD system chip.

6. The device of claim 5, wherein the memory card reader is operative to read a map data memory card or a multimedia data memory card and transmit information stored therein to the DVD system chip.

7. The device of claim 5, wherein the DVD player is operative to receive a map data DVD or a multimedia DVD.

8. The device of claim 1, wherein the DVD system chip includes a software program for processing a GPS signal and a map data.
